(19) United States
(12) Patent Application Publication
(10) Pub. No.: US 2014/0201963 A1
(43) Pub. Date: Jul. 24, 2014

(54) OVERTURNING EQUIPMENT FOR HOPPERS

(71) Applicant: Minetec S.A., Renca (CL)

(72) Inventors: Claudio ZAMORANO JONES, Renca (CL); Eduardo VASQUEZ HAUVA, Renca (CL); David QUEZADA NAVARRETE, Renca (CL)

(73) Assignee: Minetec S.A., Renca (CL)

(21) Appl. No.: 13/974,412

(22) Filed: Aug. 23, 2013

(30) Foreign Application Priority Data
Jan. 24, 2013 (CL) 0239-2013

(51) Int. Cl. B66F 3/00

(52) U.S. Cl. CPC B66F 3/00
USPC 29/402.01; 254/89 R

(57) ABSTRACT

A pyramid-shaped tower apparatus is described that will raise and turn mining hoppers for easy access to the areas or elements that need to be maintained or repaired.

### FIELD OF APPLICATION OF THE INVENTION

The present invention relates to the field of maintenance and repair of mining equipment, specifically in the field of repair of mining dump-trucks.

### PRIOR STATE OF THE ART

In on-site repairing and maintaining mining equipment hoppers, the use of high tonnage cranes to lift, rotate or turn said hoppers during welding work or while replacing elements in different parts of the hopper, is presently required. This makes site maintenance of this kind of hoppers slow and expensive as it involves hiring cranes, the time of arrival of the crane to the site and the subsequent time spent in securing cables and cable slings or engaging elements in the hopper for lifting, rotating or overturning thereof, in addition to the risks of poor mooring that could cause accidents and material losses.

There are in the state of the art patent applications such as Chilean applications numbers 2430-2003, 1876-2007, 2637-2008, and 2638-2008, which address the issue of lifting and raising the hoppers to be replaced on a truck or for their repair by using columns and hydraulic equipment. These solutions allow to raise and lower the hopper for it to be repaired without fully overturning the hopper. Another disadvantage of this apparatus is the time taken to place and secure the lifting columns of the apparatus and the risk of the hopper's falling down due to poor installation of the racks and columns.

There is also Chinese application CN102030292 which discloses a structure allowing to rotate 180 degrees a large and heavy piece of equipment, thus allowing operators to work both at the bottom and inside of the equipment. The inconvenience observed in this invention is that the piece to be repaired must be previously assembled since no lifting mechanism nor a mechanical or hydraulic mechanism allowing to rotate the equipment to be repaired is observed.

### SUMMARY OF THE INVENTION

The present invention consists of a dismountable and mobile system at the same place where the mining activities are performed, preventing the hoppers from being moved to other locations where the required maintenance and repair are performed. The system allows the hopper to be raised from the ground and to be rotated at 360°, with substantial costs savings since hiring cranes being able to reach the location to turn the hopper is not required. On the other hand, it also brings operational time savings since operations often cannot start until the arrival of the crane and mooring and securing the hopper adequately for its raising and overturning and fastening is also time-consuming. In addition, the fastening elements between the towers allow a fast and secure fastening requiring no supports between the ground and the hopper.

### BRIEF DESCRIPTION OFN THE DRAWINGS

FIG. 1 is an isometric view of the overturning apparatus with a hopper installed.

FIG. 2 is an isometric view of the overturning apparatus without the hopper.

FIG. 3 is a front view of the overturning apparatus with the hopper.

FIG. 4 is a side view of the overturning apparatus with a hopper installed.

FIG. 5 is a front and side view of tower A

FIG. 6 is a front and side view of tower B

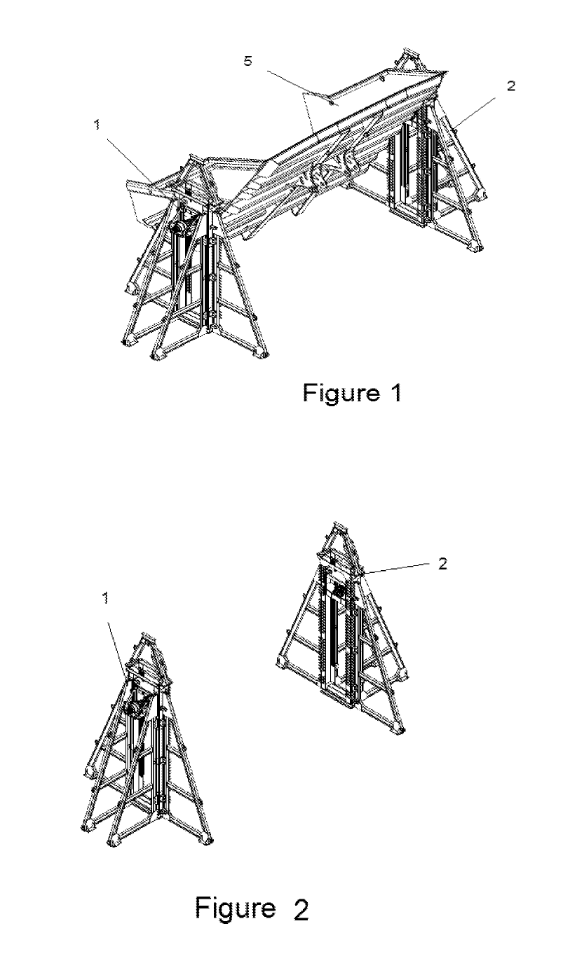

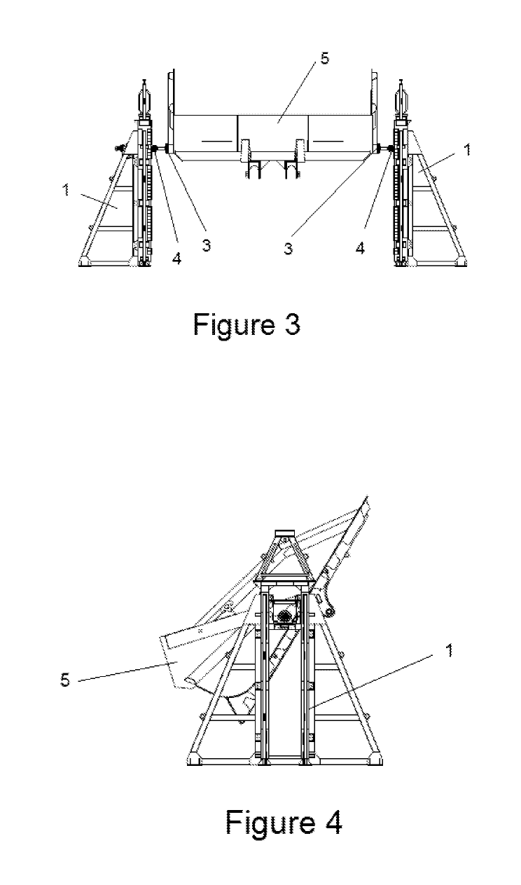

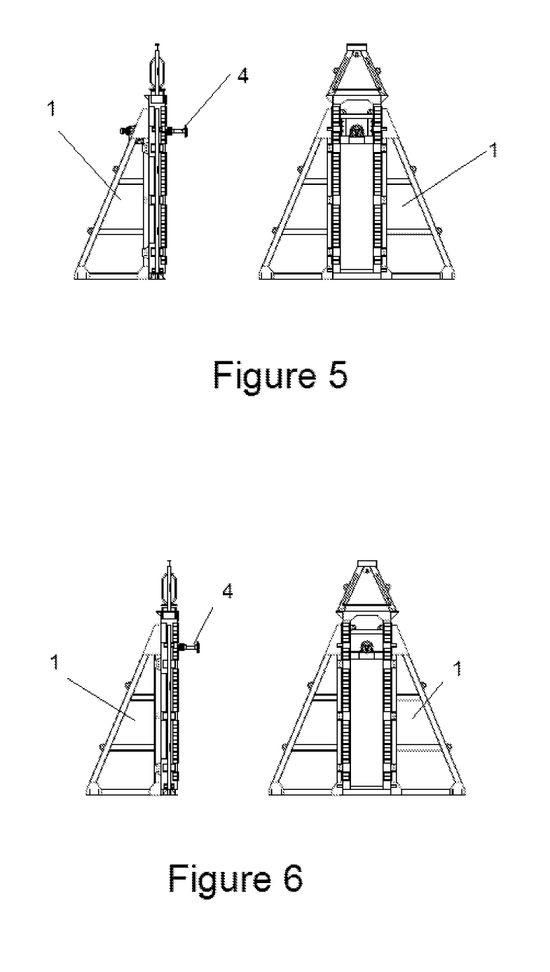

### DETAILED DESCRIPTION OF THE INVENTION

The apparatus intended to raise and turn mining hoppers is comprised of a dismountable, structural, dismountable, pyramid-shaped tower A (1) and a tower B (2) having mobile elements at both towers (1,2) which allow to raise the hopper off the ground (5) up to a specified height and rotate it to a position allowing easy access to the areas or elements to be maintained or repaired. The overturning apparatus joins the hopper by using attachable mechanical fastening means (3,4) made up of a first part (3) that is fixed on the hopper and a second part (4) that is in each one of the towers and rotates, said fastening means being of an attachable and mechanical kind (3,4) for example, Plates or Flanges, the hopper (5) getting joined to the towers (1,2) on both sides, which allows raising thereof. The first part (3) of the attachable mechanical fastening means (3,4) is preferably located as close as to the point equivalent to the center of gravity of the hopper as possible. During the raising of hopper (5) up to the desired height, the second part (4) of the mechanical attachable fastening means (3,4) remain without any rotating capacity once the height at which the hopper (5) can be lifted has been reached, without touching the ground (5), the rotating mechanism of the second part (4) of said attachable mechanical fastening means (3,4) activate. The second part (4) of the attachable mechanical fastening means (3,4) rises and spins on the towers by moving means allowing, in turn, to raise and rotate the hopper (5). Once turned, the hopper (5) may remain fixed at a proper height and angular position to work thereon. The hopper overturning apparatus has hydraulic or electrical safety mechanisms that prevent the hopper from falling down accidentally. The overturning apparatus also has raising mechanisms allowing to lift the hopper and which can mechanical, electrical or hydraulic.

Below is disclosed a method for using the apparatus, comprising the steps of:

a) Providing a level surface area;

b) Providing two dismounted structural towers (1,2) with second parts of the mechanical fastening elements (3,4) , raising and overturning mechanisms and with safety systems;

c) Assembling the two towers (1,2) on the level surface area;

d) Locating between the two towers (1,2) a hopper (5), wherein said hopper (5) has, on each side, a first part of a attachable mechanical fastening element (3) to the second parts of the mechanical fastening elements (4) of the towers;

e) Bolting the second parts of the mechanical fastening elements (4) to the first parts of the mechanical fastening elements (3);

f) Raising the hopper (5) up to a desired height or to a height as allowed by the overturning;

g) Overturning the hopper (5); and

h) Repairing the hopper (5).

What is claimed is:

1. An apparatus for on-site repairing truck hoppers that positions the hopper thus facilitating the repair and maintenance of the elements and areas to be repaired and avoids the use of cranes, comprising:
a) Two structural dismountable towers having mobile elements, their height allowing to raise and turn the hopper;
b) Attachable, mechanical fastening means comprising:
at least one first part that is fixed to the hopper;
at least a second rotatable part that is fixed on the towers of the apparatus.
c) safety mechanisms;
d) Raising mechanisms.

2. An apparatus to repair hoppers according to claim 1, wherein the overturning of the hopper ranges from 0° to 360°.

3. The apparatus to repair hoppers according to claim 1, wherein the first and second parts of the fastening mean allow to fix the hopper to the towers of the overturning system.

4. The apparatus to repair hoppers according to claim 1, wherein the second parts of the fastening means rise up the towers through moving means thus allowing, in turn, to lift and turn the hopper.

5. The apparatus to repair hoppers according to claim 1, wherein the fastening means are preferably plates or flanges.

6. The apparatus to repair hoppers according to claim 1, wherein the safety mechanism can be mechanical, electrical or hydraulic.

7. The apparatus to repair hoppers according to claim 1, wherein the raising mechanisms of the hopper can be mechanical, electrical or hydraulic.

8. The apparatus to repair hoppers according to claim 1, wherein the second rotating part of the Fastening means remains without rotating capacity during hopper lifting.

9. A method of using an apparatus to repair on site truck hoppers that positions the hopper, facilitating the repair and maintenance of the elements and areas to be repaired and avoiding the use of cranes, comprising the steps of:
a) Providing a level surface area;
b) Providing two dismounted structural towers (1,2) with second parts of the mechanical fastening elements (3,4), raising and overturning mechanisms and with safety systems;
c) Assembling the two towers (1,2) on the level surface area;
d) Locating between the two towers (1,2) a hopper (5), wherein said hopper (5) has, on each side, a first part of a attachable mechanical fastening element (3) to the second parts of the mechanical fastening elements (4) of the towers;
e) Bolting the second parts of the mechanical fastening elements (4) to the first parts of the mechanical fastening elements (3);
f) Raising the hopper (5) up to a desired height or to a height as allowed by the overturning;
g) Overturning the hopper (5); and
h) Repairing the hopper (5).
